(19) United States
(12) Patent Application Publication
(10) Pub. No.: US 2015/0372818 A1
(43) Pub. Date: Dec. 24, 2015

(54) Algebraic Symmetric Cipher

(71) Applicant: Charles Fairbanks Sauerbier, Chesapeake, VA (US)

(72) Inventor: Charles Fairbanks Sauerbier, Chesapeake, VA (US)

(21) Appl. No.: 14/331,584

(22) Filed: Jul. 15, 2014

Related U.S. Application Data
(60) Provisional application No. 62/014,286, filed on Jun. 19, 2014.

(51) Int. Cl. H04L 9/30; H04L 9/08

(52) U.S. Cl. CPC H04L 9/3066; H04L 9/0819; H04L 2209/24

(57) ABSTRACT

An algebraic symmetric cipher is provided. The cipher does not employ methods of presently known symmetric ciphers as its basis. The cipher relies on an information loss in transformation of input data (plaintext) to output data (cipher-text), where information loss is non-invertible in absence of cipher key materials, and; is reliant on an inverse information gain in transformation of input data (cipher-text) into output data (plaintext), where information gain is obtained operations making use of cipher key materials.

### CROSS-REFERENCES TO RELATED APPLICATIONS

Not Applicable

### BACKGROUND

The present invention relates to ciphers. In particular, the invention relates to symmetric ciphers, and; more specifically to an algebraic symmetric cipher.

The protection of information by application of ciphers has a long history. A common means for protection of data is the use of a cipher. There exist two fundamental classes of cipher algorithms—symmetric and asymmetric.

Within the family of symmetric ciphers there exist two sub-classifications: block ciphers and stream ciphers. Symmetric ciphers methods commonly known rely primarily on key material comprised of random bits composed as either blocks or streams.

The majority of block ciphers today employ some variation of a substitution-permutation network, or either Feistel or Lai-Massey ciphers. Feistel and Lai-Massey ciphers encipher blocks of data split into two disjoint sub-blocks on which some set of operations are performed, where such operation may include substitution and/or permutation. The function of common symmetric ciphers is to replace (substitute) information in a plaintext block with information from the key so as to make the plaintext retrievable by reversal of the enciphering operations. In this manner the plaintext information is not itself communicated, but rather a kind of pseudo-language instruction set to a processor is provided by which the plaintext can be reproduced by decipherment.

Symmetric stream ciphers methods commonly known rely primarily on either bit-wide or byte-wide logical operations to encipher plaintext using the random bits of the key material by application of an exclusive-OR operator.

A paper available electronically from the internet and presented as published in the 2010 International Journal of Computer Application, Volume 1, Number 15, presents a single found instance of prime modular mathematics as basis of symmetric cipher. However, the presented method of the paper is readily compromised by known plaintext attack. The method is also not difficult to subvert by brute force for a known space of plaintext messages of constrained alphabet. The weaknesses of the method result in limited utility for the specific approach.

Use of modular mathematics within the field of cryptography is commonly found used in secure hashing algorithms. The use there premised on the assumed difficulty of computing a modular inverse, thus making the congruence function (modulus) effectively a one-way-function for all practical purposes. The function of modulus in hash algorithms is principally to constrain the resulting hash to a specific number of bits. However, in secure hashing algorithms there is also the objective of achieving a non-invertible factor in the computation.

### SUMMARY OF INVENTION

The object of invention is a symmetric cipher. A further object of invention is a symmetric cipher premised on key material comprised of one or more prime numbers. A further object of invention is a symmetric cipher premised on a mathematical modulus as primary operator of cipher. A further object of invention is a symmetric cipher reliant on “information loss” for cipher strength.

The invention provides an cipher system comprised of: an encipher operation component, and; a decipher operation component, and; a cipher key material comprised of a key-sentinel and a key modulus.

The invention functions to transform plaintext to cipher-text by performing one or more encipher operations on plaintext.

The invention functions to transform cipher-text encrypted using encipher operations to plaintext by performing one or more complementary (inverse) decipher operations on cipher-text.

### BRIEF DESCRIPTION OF DRAWINGS

FIG. 1 presents a diagrammatic representation of data elements comprising a key-primitive 100 according to an embodiment of present invention.

FIG. 2 presents a diagrammatic representation for a key-vector 114 according to an embodiment of present invention.

FIG. 3 presents a diagrammatic representation for an index-mask 116 according to an embodiment of present invention.

FIG. 4 presents a diagrammatic representation for a sentinel-composite 118 according to an embodiment of present invention.

FIG. 5 presents a diagrammatic representation for a leading-zero suppression data structure 130 according to an embodiment of present invention.

FIG. 6 presents a diagrammatic representation for an indexed-text data structure 140 according to an embodiment of present invention.

FIG. 7 presents a diagrammatic representation for a sentinel locator operation component 160 according to an embodiment of present invention.

FIG. 8 presents a diagrammatic representation for a sentinel locator with index operation component 180 according to an embodiment of present invention.

FIG. 9 presents a diagrammatic representation for an encipher-primitive operation component 200 according to an embodiment of present invention.

FIG. 10 presents a diagrammatic representation for an encipher-primitive with composite sink operation component 300 according to an embodiment of present invention.

FIG. 11 presents a diagrammatic representation for a decipher-primitive operation component 400 according to an embodiment of present invention.

FIG. 12 presents a diagrammatic representation for a decipher-primitive with index operation component 500 according to an embodiment of present invention.

FIG. 13 presents a diagrammatic representation for an encipher vector group operation component 600 according to an embodiment of present invention.

FIG. 14 presents a diagrammatic representation for a decipher vector group operation component 700 according to an embodiment of present invention.

FIG. 15 presents a diagrammatic representation for an encipher feedback group operation component 800 according to an embodiment of present invention.

FIG. 16 presents a diagrammatic representation for a decipher feedback group operation component 900 according to an embodiment of present invention.

FIG. 17 presents a diagrammatic representation for a leading-zero suppression operation component 1000 according to an embodiment of present invention.

FIG. 18 presents a diagrammatic representation for a leading-zero expansion operation component 1100 according to an embodiment of present invention.

FIG. 19 presents a diagrammatic representation for an indexed-text composition operation component 1200 according to an embodiment of present invention.

FIG. 20 presents a diagrammatic representation for an indexed-text decomposition operation component 1300 according to an embodiment of present invention.

FIG. 21 presents a diagrammatic representation for an indexed-text composition with leading-zero suppression operation component 1400 according to an embodiment of present invention.

FIG. 22 presents a diagrammatic representation for an indexed-text decomposition with leading-zero expansion operation component 1500 according to an embodiment of present invention.

FIG. 23 presents a diagrammatic representation for an index computation operation component 1600 according to an embodiment of present invention.

FIG. 24 presents a diagrammatic representation for an indexed-text producer component 1700 according to an embodiment of present invention.

FIG. 25 presents a diagrammatic representation for compositions of an encipher preprocessor component 1800 according to an embodiment of present invention.

FIG. 26 presents a diagrammatic representation for compositions of an decipher post-processor component 1900 according to an embodiment of present invention.

FIG. 27 presents a diagrammatic representation for compositions of an encipher component 2000 according to an embodiment of present invention.

FIG. 28 presents a diagrammatic representation for compositions of an decipher component 2100 according to an embodiment of present invention.

FIG. 29 presents a diagrammatic representation for compositions of an indexed encipher component 2200 according to an embodiment of present invention.

FIG. 30 presents a diagrammatic representation for compositions of an indexed decipher component 2300 according to an embodiment of present invention.

FIG. 31 presents a diagrammatic representation for compositions of an encipher processor 2400 according to an embodiment of present invention.

FIG. 32 presents a diagrammatic representation for compositions of a decipher processor 2500 according to an embodiment of present invention.

FIG. 33 presents a diagrammatic representation for compositions of a feedback encipher processor 2600 according to an embodiment of present invention.

FIG. 34 presents a diagrammatic representation for compositions of a feedback decipher processor 2700 according to an embodiment of present invention.

### DESCRIPTION OF INVENTION

### Data Elements

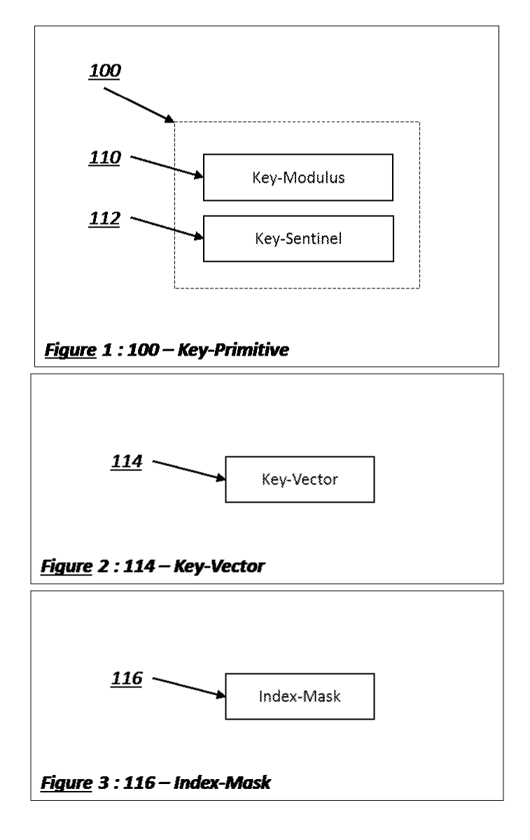

A key-primitive 100, depicted in FIG. 1, according to an embodiment of present invention, is comprised of a key-modulus 110 data element and a key-sentinel 112 data element. A key-modulus 110, according to an embodiment of the present invention, is a prime number. A key-sentinel 114, according to an embodiment of present invention, is a data value that when combined in encryption process with a text value by an invertible sentinel-forming operation acts as a sentinel in an inverse modulus operation in decryption process.

A key-vector 114, depicted in FIG. 2, according to an embodiment of present invention, is a data value that when combined in encryption process with a text value by an operation acts to provide a “confusion” element to a cipher.

An index-mask 116, depicted in FIG. 3, according to an embodiment of present invention, is a data value that when combined in encryption process with a text value by an operation acts to provide a “confusion” element to an index value in cipher.

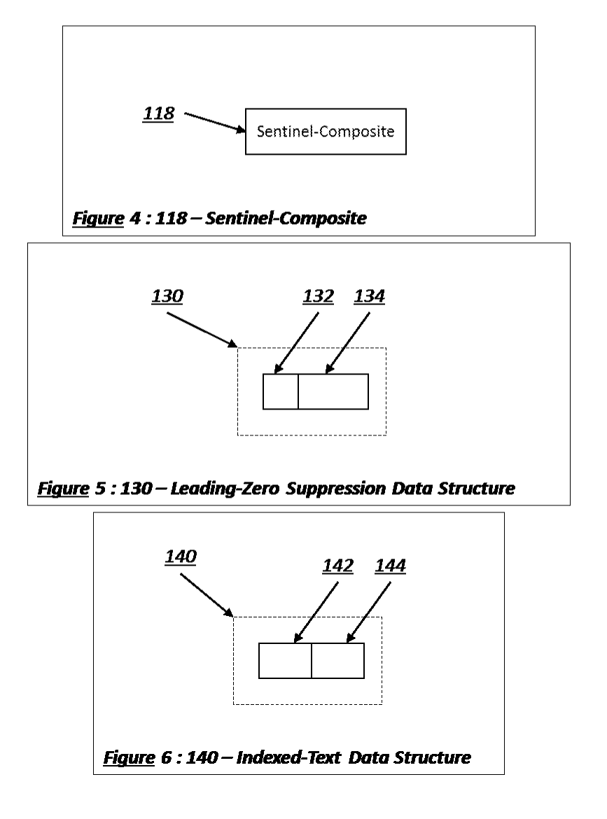

A sentinel-composite 118, depicted in FIG. 4, according to an embodiment of present invention, is a unit of data produce by an operation functioning as a sentinel-forming operation to combine a key-sentinel 112 with a text value.

A leading-zero suppression data structure 130, depicted in FIG. 5, according to an embodiment of present invention, is a data structure comprised of two data elements: a size data element 132 and a text data element 134. Size data element 132 of leading-zero suppression data structure 130, according to an embodiment of present invention, is a data value that represents the size of text data element 134. Text data element 134 of a leading-zero suppression data structure 130, according to an embodiment of present invention, is a data value resulting from elimination of leading-zero values from a processed text value. The size of size data element 132, according to an embodiment of the present invention, is a known parameter of leading-zero suppression and expansion operations. The size of text value processed prior to suppression of leading zero values, according to an embodiment of the present invention, is a known parameter of leading-zero suppression and expansion operations.

An indexed-text data structure 140, depicted in FIG. 6, according to an embodiment of present invention, is a data structure comprised of two data elements: an index data element 142 and a text data element 144. Index data element 142 of an indexed text data structure 140, according to an embodiment of present invention, is a data value that represents a computed index of a sentinel-composite 118 predecessor of text data element 144. Text data element 144 of an indexed text data structure 140, according to an embodiment of present invention, is a unit of data as text for which predecessor index contained in index data element 142 was computed.

### Component Elements

### Sentinel Locator Operation Component 160

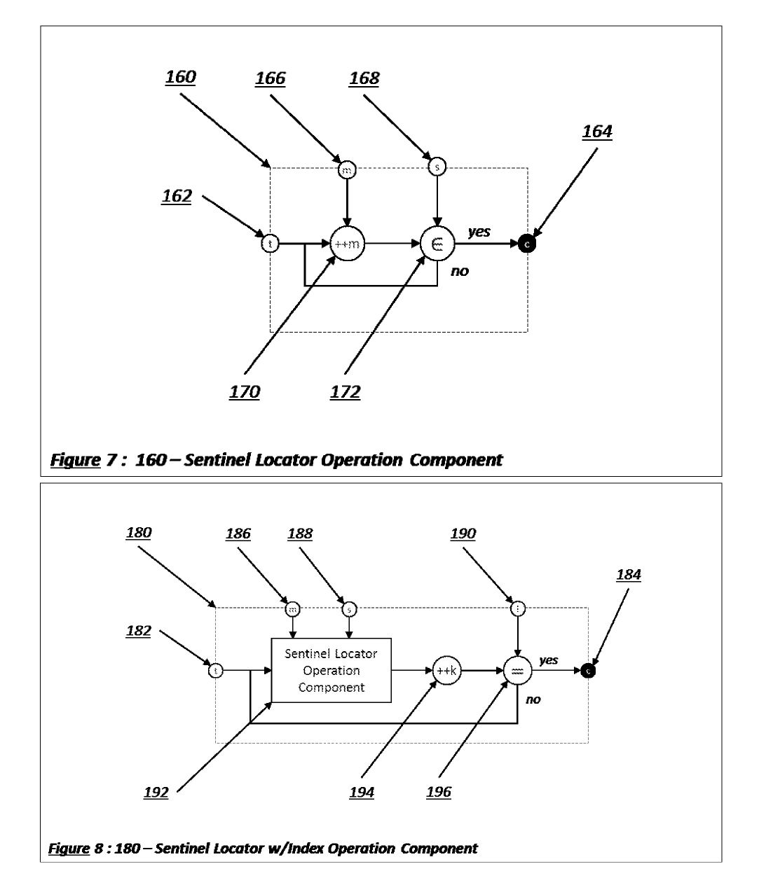

A sentinel locator operation component 160, depicted in FIG. 7, according to an embodiment of present invention, is comprised of:
(1) an interface comprised of a text source 162, and sentinel-composite sink 164, a key-modulus source 166, a key-sentinel source 168, and;
(2) a set of operators comprised of an increment-by-modulus operator 170, a contains-sentinel-check operator 172.

An increment-by-modulus operator 170 is an additive mathematical group operation on two parameter values, where said parameters are a unit of data as text value and a key-modulus 110 value in an embodiment of present invention.

A sentinel locator operation component 160, according to an embodiment of present invention, works by repetitively incrementing a partial result value from an initial value of text by a value of a key-modulus 110 until a key-sentinel 112 is located in result of increment operation.

A sentinel locator operation component 160, according to an embodiment of present invention:
(1) accepts a unit of data as text at text source 162, accepts a key-modulus 110 at key-modulus source 166, accepts a key-sentinel 112 at key-sentinel source 168, and;
(2) performs an operation on text accepted at text source 162, with key-modulus 110 accepted at key-modulus source 166, using increment-by-modulus operator 170, and;
(3) performs a check for key-sentinel 112 accepted at key-sentinel source 168 in result produced by increment-by-modulus operator 170, using contains-sentinel-check operator 172, and;
(4) where check for said key-sentinel 112 is unsuccessful performs an operation on last result produced by increment-by-modulus operator 170 using increment-by-modulus operator 170, and repeats from (3) a check for key-sentinel 112, and;
(5) where check for said key-sentinel 112 is successful presents result last produced by increment-by-modulus operator 170 at sentinel-composite sink 164.
   Sentinel Locator with Index Operation Component 180

A sentinel locator with index operation component 180, depicted in FIG. 8, according to an embodiment of present invention, is comprised of:
(1) an interface comprised of a text source 182, and sentinel-composite sink 184, a key-modulus source 186, a key-sentinel source 188, an index source 190, and;
(2) a sentinel locator operation component 192, and;
(3) a set of operators comprised of an index-counter operator 194, an is-index-check operator 196.

A sentinel locator operation component 192, according to an embodiment of present invention, is an instance of sentinel locator operation component 160.

A sentinel locator with index operation component 180, according to an embodiment of present invention, works by incrementing a counter when a sentinel-composite instance is produced by sentinel locator operation component 192 until an index-counter operator 194 result is equivalent to an index parameter value accepted at index source 190.

A sentinel locator with index operation component 180, according to an embodiment of present invention:
(1) accepts a unit of data in form of indexed-text data structure 140 as text at text source 182, accepts a key-modulus 110 at key-modulus source 186, accepts a key-sentinel 112 at key-sentinel source 188, accepts a unit of data as index value at index source 190, and;
(2) performs a sentinel locator operation, with text accepted at text source 182, and key-modulus 110 accepted at key-modulus source 186, and key-sentinel 112 accepted at key-sentinel source 188, using sentinel locator operation component 192, and;
(3) performs an index count increment operation where a result is produced by sentinel locator operation component 192 using index-counter operator 194, and;
(4) performs an equivalence operation, with result of index-counter operator 194 and index value accepted at index source 190, using is-index-check operator 196, and;
(5) where equivalence operation of is-index-check operator 196 is unsuccessful repeats sentinel locator operation using last result produced by sentinel locator operation component 192 as text value, and;
(6) where equivalence operation of is-index-check operator 196 is successful presents last result produced by sentinel locator operation component 192 at sentinel-composite sink 184.

### Encipher-Primitive Operation Component 200

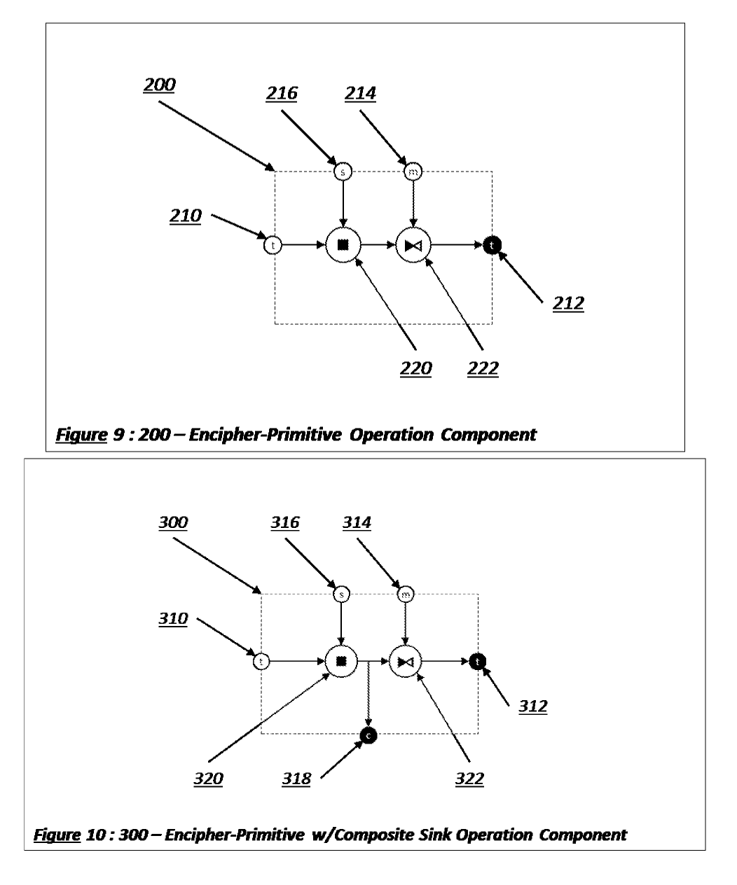

An encipher-primitive operation component 200, depicted in FIG. 9, according to an embodiment of present invention, is comprised of:
(1) an interface comprised of a text source 210, a text sink 212, a key-modulus source 214, a key-sentinel source 216, and;
(2) a set of operators comprised of a sentinel-forming operator 220, a modulus operator 222.

A sentinel-forming operator 220 is an operation that is invertible and combines a key-sentinel 112 with a unit of data as text in such manner as result produced is detectable as a sentinel by an operation that checks for existence of sentinel formed by said sentinel-forming operator 220.

An encipher-primitive operation component 200, according to an embodiment of present invention:
(1) accepts a unit of data as text at text source 210, accepts a key-modulus 110 at key-modulus source 214, accepts a key-sentinel 112 at key-sentinel source 216, and;
(2) performs a sentinel-forming operation, with text accepted at text source 210 and key-sentinel 112 accepted at key-sentinel source 216, using sentinel-forming operator 220 to produce a sentinel-composite 118, and;
(3) performs a modulus operation, with resulting sentinel-composite 118 produced by sentinel-forming operator 220 and key-modulus 110 accepted at key-modulus source 214, using modulus operator 222, and;
(4) presents result produced by modulus operator 222 at text sink 212.
   Encipher-Primitive with Composite Sink Operation Component 300

An encipher-primitive with composite sink operation component 300, depicted in FIG. 10, according to an embodiment of present invention, is comprised of:
(1) an interface comprised of a text source 310, a text sink 312, a key-modulus source 314, a key-sentinel source 316, a sentinel-composite sink 318, and;
(2) a set of operators comprised of a sentinel-forming operator 320, a modulus operator 322.

A sentinel-forming operator 320, according to an embodiment of present invention, is an instance of a sentinel-forming operator 220.

A modulus operator 320, according to an embodiment of present invention, is an instance of a modulus operator 222.

An encipher-primitive with composite sink operation component 300, according to an embodiment of present invention, is functionally equivalent to an encipher-primitive operation component 200, except that the result, a sentinel-composite 118, of sentinel-forming operator 320 is presented at a sentinel-composite sink 318.

An encipher-primitive with composite sink operation component 300, according to an embodiment of present invention:
(1) accepts a unit of data as text at text source 310, accepts a key-modulus 110 at key-modulus source 314, accepts a key-sentinel 112 at key-sentinel source 316, and;
(2) performs a sentinel-forming operation, with text accepted at text source 310 and key-sentinel 112 accepted at key-sentinel source 316, using sentinel-forming operator 320, and;
(3) presents a sentinel-composite 118 produced as result by sentinel-forming operator 320 at sentinel-composite sink 318, and;
(4) performs a modulus operation, with sentinel-composite 118 produced as result by sentinel-forming operator 320 and key-modulus 110 accepted at key-modulus source 314, using modulus operator 322, and;
(5) presents result produced by modulus operator 322 at text sink 312.

### Decipher-Primitive Operation Component 400

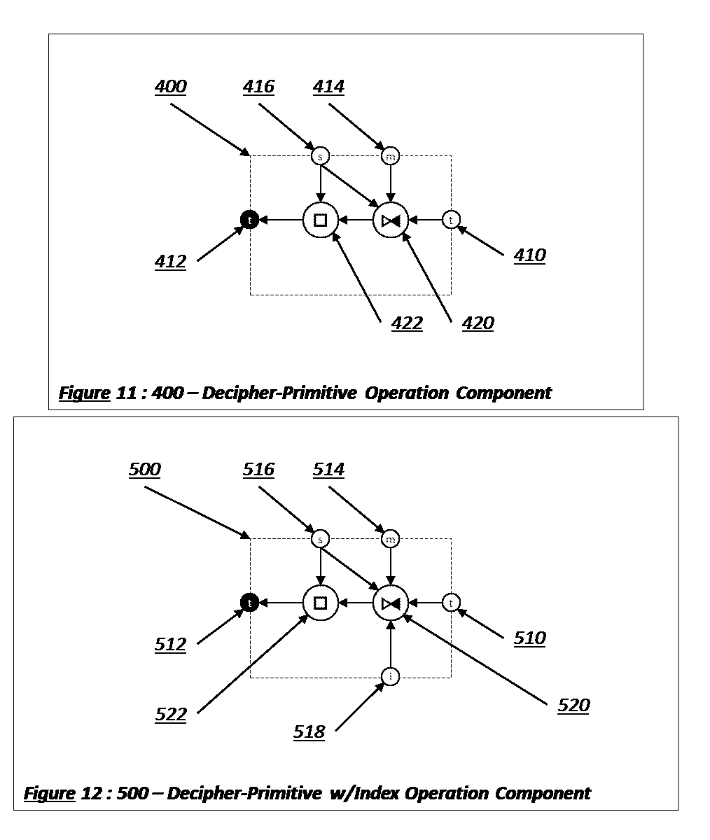

A decipher-primitive operation component 400, depicted in FIG. 11, according to an embodiment of present invention, is comprised of:
(1) an interface comprised of a text source 410, a text sink 412, a key-modulus source 414, a key-sentinel source 416, and;
(2) a set of operators comprised of an inverse-modulus operator 420, a sentinel-reduction operator 422.

A sentinel-reduction operator 422, according to an embodiment of present invention, is an inverse operation to a corresponding sentinel-forming operator 220.

An inverse-modulus operator 420, according to an embodiment of present invention, is an instance of a sentinel locator operation component 160

A decipher-primitive operation component 400, according to an embodiment of present invention:
(1) accepts a unit of data as text at text source 410, accepts a key-modulus 110 at key-modulus source 414, accepts a key-sentinel 112 at key-sentinel source 416, and;
(2) performs an inverse-modulus operation, with text accepted at text source 410 and key-modulus 110 accepted at key-modulus source 414 and key-sentinel 112 accepted at key-sentinel source 416, using inverse-modulus operator 420, and;
(3) performs a sentinel-reduction operation, with result produced by inverse-modulus operator 420 and key-sentinel 112 accepted at key-sentinel source 416, using sentinel-reduction operator 422 to extract a unit of data as text with which key-sentinel 112 was combined by a corresponding sentinel-forming operator 220 to which sentinel-reduction operator 422 is a functional inverse, and;
(4) presents result produced by sentinel-reduction operator 422 at text sink 412.
   Decipher-Primitive with Index Operation Component 500

A decipher-primitive with index operation component 500, depicted in FIG. 12, according to an embodiment of present invention, is comprised of:
(1) an interface comprised of a text source 510, a text sink 512, a key-modulus source 514, a key-sentinel source 516, an index source 518, and;
(2) a set of operators comprised of an inverse-modulus operator 520, a sentinel-reduction operator 522.

A sentinel-reduction operator 522, according to an embodiment of present invention, is an instance of a sentinel-reduction operator 422.

An inverse-modulus operator 520, according to an embodiment of present invention, is an instance of a sentinel locator with index operation component 180.

A decipher-primitive with index operation component 500, according to an embodiment of present invention:
(1) accepts a unit of data as text at text source 510, accepts a key-modulus 110 at key-modulus source 514, accepts a key-sentinel 112 at key-sentinel source 516, accepts an index value at index source 518, and;
(2) performs an inverse-modulus operation, with text accepted at text source 510 and key-modulus 110 accepted at key-modulus source 514 and key-sentinel 112 accepted at key-sentinel source 516 and index value accepted at index source 518, using inverse-modulus operator 520, and;
(3) performs a sentinel-reduction operation, with a result produced by inverse-modulus operator 520 and key-sentinel 112 accepted at key-sentinel source 516, using sentinel-reduction operator 522, and;
(4) Presents a result produced by sentinel-reduction operator 522 at text sink 512.

### Encipher Vector Group Operation Component 600

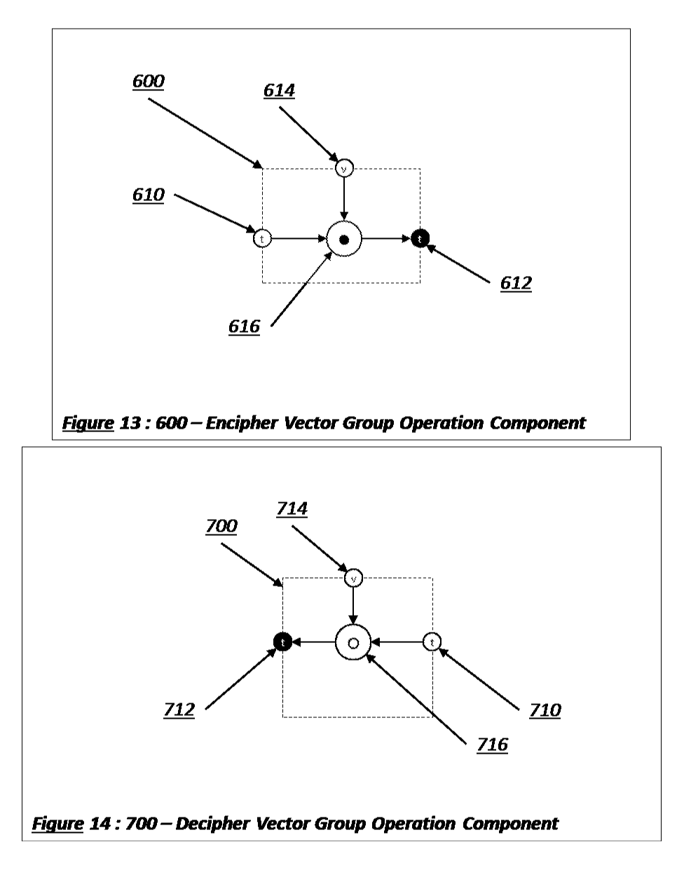

An encipher vector group operation component 600, depicted in FIG. 13, according to an embodiment of present invention, is comprised of:
(1) an interface comprised of a text source 610, a text sink 612, a key-vector source 614, and;
(2) a group operator 616.

A group operator 616, according to an embodiment of present invention, is an operation that possesses the properties defining of an operation of a mathematical group structure.

An encipher vector group operation component 600, according to an embodiment of present invention:
(1) accepts a unit of text at text source 610, accepts a key-vector 114 at key-vector source 614, and;
(2) performs an operation, with text accepted at text source 610 and key-vector 114 accepted at key-vector source 614, using group operator 616, and;
(3) presents a result produced by group operator 616 at text sink 612.

A cipher vector group operation component 600 serves to incorporate a “confusion” element to a cipher according to an embodiment of present invention.

### Decipher Vector Group Operation Component 700

A decipher vector group operation component 700, depicted in FIG. 14, according to an embodiment of present invention, is comprised of:
(1) an interface comprised of a text source 710, a text sink 712, a key-vector source 714, and;
(2) a group operator 716.

A group operator 716, according to an embodiment of present invention, is a functional inverse to a corresponding group operator 616. A group operator 716, according to an embodiment of present invention, serves the effective purpose of an inverse operator within a mathematical group structure. Examples of mathematical operators functioning as inverses within a mathematical group structure being the commonly understood functions of “addition” and “subtraction”.

A decipher vector group operation component 700, according to an embodiment of present invention:
(1) accepts a unit of text at text source 710, accepts a key-vector 114 at key-vector source 714, and;
(2) performs an operation, with text accepted at text source 710 and key-vector 114 accepted at key-vector source 714, using group operator 716, and;
(3) presents a result produced by group operator 716 at text sink 712.

### Encipher Feedback Group Operation Component 800

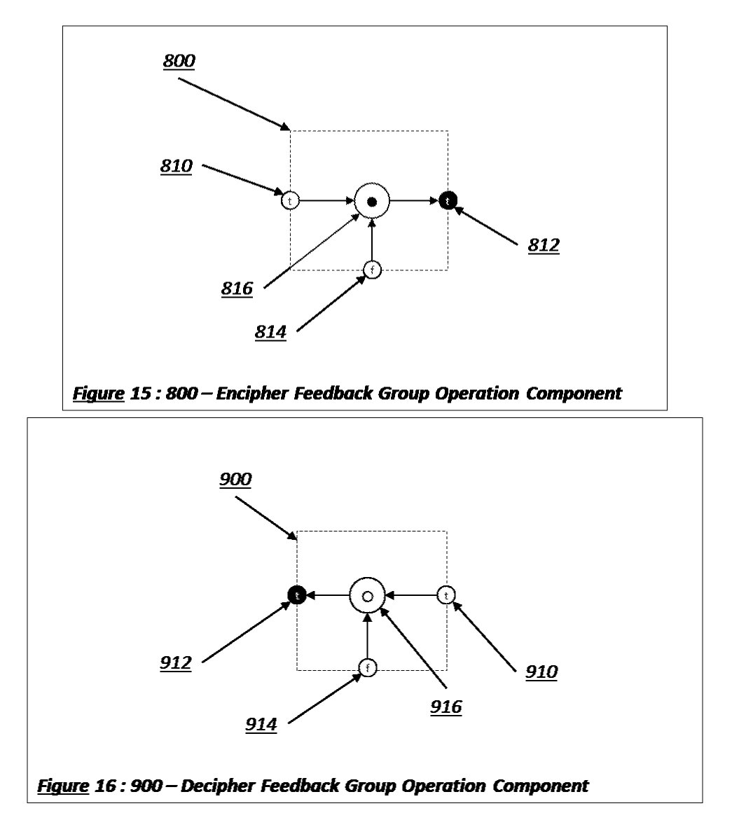

An encipher feedback group operation component 800, depicted in FIG. 15, according to an embodiment of present invention, is comprised of:
(1) an interface comprised of a text source 810, a text sink 812, a key-feedback source 814, and;
(2) a group operator 816.

A group operator 816, according to an embodiment of present invention, is an operation that possesses the properties defining of an operation of a mathematical group structure.

An encipher feedback group operation component 800, according to an embodiment of present invention:
(1) accepts a unit of text at text source 810, accepts a unit of data as feedback at feedback source 814, and;
(2) performs an operation, with text accepted at text source 810 and unit of data as feedback accepted at feedback source 814, using group operator 816, and;
(3) presents a result produced by group operator 816 at text sink 812.

A encipher feedback group operation component 800 serves to provide a “diffusion” element to a cipher according to an embodiment of present invention

### Decipher Feedback Group Operation Component 900

A decipher feedback group operation component 900, depicted in FIG. 16, according to an embodiment of present invention, is comprised of:
(1) an interface comprised of a text source 910, a text sink 912, a feedback source 914, and;
(2) a group operator 916.

A group operator 916, according to an embodiment of present invention, is a functional inverse to a corresponding group operator 816. A group operator 916, according to an embodiment of present invention, serves the effective purpose of an inverse operator within a mathematical group structure. Examples of mathematical operators functioning as inverses within a mathematical group structure being the commonly understood functions of “addition” and “subtraction”.

A decipher feedback group operation component 900, according to an embodiment of present invention:
(1) accepts a unit of text at text source 910, accepts a unit of data as feedback at feedback source 914, and;
(2) performs an operation, with text accepted at text source 910 and unit of data accepted at feedback source 914, using group operator 916, and;
(3) presents a result produced by group operator 916 at text sink 912.

### Leading-Zero Suppression Operation Component 1000

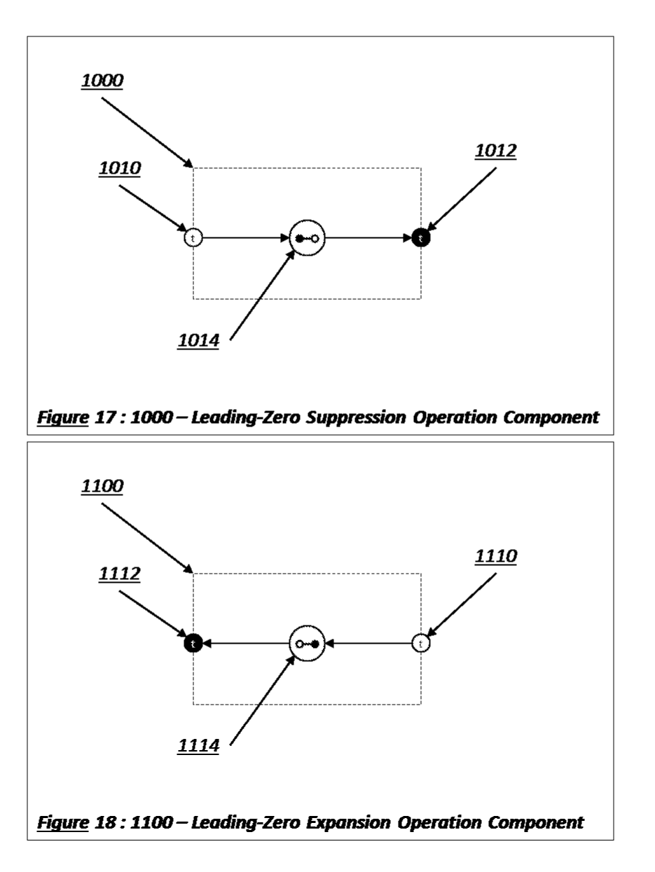

A leading-zero suppression operation component 1000, depicted in FIG. 17, according to an embodiment of present invention, is comprised of:
(1) an interface comprised of a text source 1010, a text sink 1012, and;
(2) a leading-zero suppression operator 1014.

A leading-zero suppression operation component 1000, according to an embodiment of present invention, removes leading-zero values from a representation of a text data element processed and produces a leading-zero suppression data structure 130.

A leading-zero suppression operation 1014, according to an embodiment of present invention, operates on data processed in context of data's representation to reduce the representation of data processed by removal of leading zero values in data representation. A data value represented by a sequence of binary bits, e.g. 0000000000101011, is reduced to a sequence of binary bits, e.g. 101011, and formed into an instance of suppression data structure 130 as a binary representation, e.g. 00000110101011, where 00000110 is an instance of size data element 132 and 101011 is an instance of text data element 134. The size of data accepted at text source 1010 for processing, according to an embodiment of present invention, is a known parameter of leading-zero suppression and expansion processing.

A leading-zero suppression operation component 1000, according to an embodiment of present invention:
(1) accepts a unit of data as text at text source 1010, and;
(2) performs an operation, with text accepted at text source 1010, using leading-zero suppression operator 1014 to produce a leading-zero suppression data structure 130, and;
(3) presents a result produced by leading-zero suppression operation 1014 at text sink 1012.

### Leading-Zero Expansion Operation Component 1100

A leading-zero expansion operation component 1100, depicted in FIG. 18, according to an embodiment of present invention, is comprised of:
(1) an interface comprised of a text source 1110, a text sink 1112, and;
(2) a leading-zero expansion operator 1114.

A leading-zero expansion operation component 1100, according to an embodiment of present invention, inserts leading-zero values into a representation of a text data element processed and reproduces a text data element as was processed by leading-zero suppression operator 1014.

A leading-zero expansion operator 1114, according to an embodiment of present invention, operates on data processed in context of data's representation to expand the representation of data processed by insertion of leading zero values into data representation. A data value represented by a sequence of binary bits, e.g. 00000110101011, is expanded to a sequence of binary bits, e.g. 0000000000101011, restoring data element to size prior to suppression of leading-zero values. The size of data element to be presented at text sink 1112, according to an embodiment of present invention, is a known parameter of leading-zero suppression and expansion processing.

A leading-zero expansion operation component 1100, according to an embodiment of present invention:
(1) accepts a leading-zero suppression data structure 130 at text source 1110, and;
(2) performs an operation, with leading-zero suppression data structure 130 accepted at text source 1110, using leading-zero expansion operator 1114 to produce a text value without suppressed leading-zero values, and;
(3) presents a result produced by leading-zero expansion operator 1114 at text sink 1112.

### Indexed-Text Composition Operation Component 1200

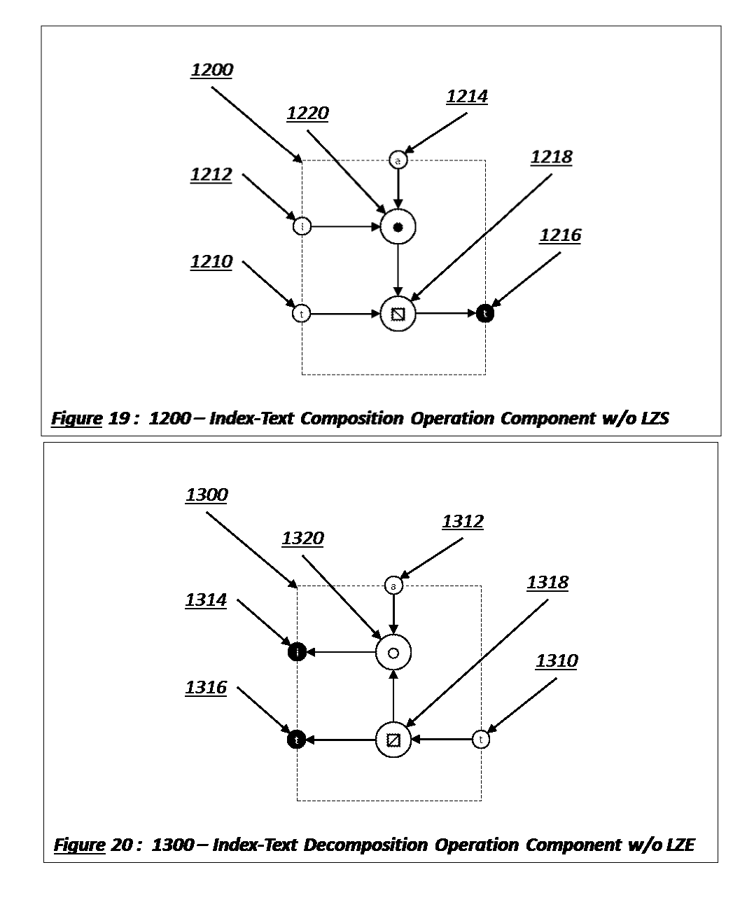

An indexed-text composition operation component 1200, depicted in FIG. 19, according to an embodiment of present invention, is comprised of:
(1) an interface comprised of a text source 1210, an index source 1212, a mask source 1214, a text sink 1216, and;
(2) a set of operators consisting of a data structure operator 1218, a group operator 1220.

A group operator 1220, according to an embodiment of present invention, is an operation that possesses the properties defining of an operation of a mathematical group structure.

An indexed-text composition operation component 1200, according to an embodiment of present invention:
(1) accepts a unit of text at text source 1210, accepts a unit of data as an index value at index source 1212, accepts an index-mask 116 at mask source 1214, and;
(2) performs an operation, with index value accepted at index source 1212 and index-mask 116 accepted at mask source 1214, using group operator 1220, and;
(3) performs an operation, with result produced by group operator 1220 and text value accepted at text source 1210, using data structure operation 1218 to produce an indexed-text data structure 140, and;
(4) presents a result produced by data structure operator 1218 at text sink 1216.

A group operator 1220 serves to incorporate a “confusion” element to a cipher in regards index data element 142 of an indexed-text data structure 140 according to an embodiment of present invention.

### Indexed-Text Decomposition Operation Component 1300

An indexed-text decomposition operation component 1300, depicted in FIG. 20, according to an embodiment of present invention, is comprised of:
(1) an interface comprised of a text source 1310, a mask source 1312, an index sink 1314, a text sink 1316, and;
(2) a set of operators consisting of a data splitter operator 1318, a group operator 1320.

A group operator 1320, according to an embodiment of present invention, is a functional inverse to a corresponding group operation 1220. A group operator 1320, according to an embodiment of present invention, serves the effective purpose of an inverse operator within a mathematical group structure. Examples of mathematical operators functioning as inverses within a mathematical group structure being the commonly understood functions of “addition” and “subtraction”.

An indexed-text decomposition operation component 1300, according to an embodiment of present invention:
(1) accepts an indexed-text data structure 140 as a unit of text at text source 1310, accepts an index-mask 116 at mask source 1312, and;
(2) performs an operation, with text value accepted at text source 1310, using data splitting operation 1318 to produce index data element 142 and text data element 144 as independent units of data, and;
(3) performs an operation, with index data element 142 as index value as a result of data splitting operation 1318 and index-mask 116 accepted at mask source 1312, using group operator 1320, and;
(4) presents a result of group operator 1320 at index sink 1314, and;
(5) presents text data element 144 as text value as a result of data splitting operation 1318 at text sink 1316.
   Indexed-Text Composition w/LZS Operation Component 1400

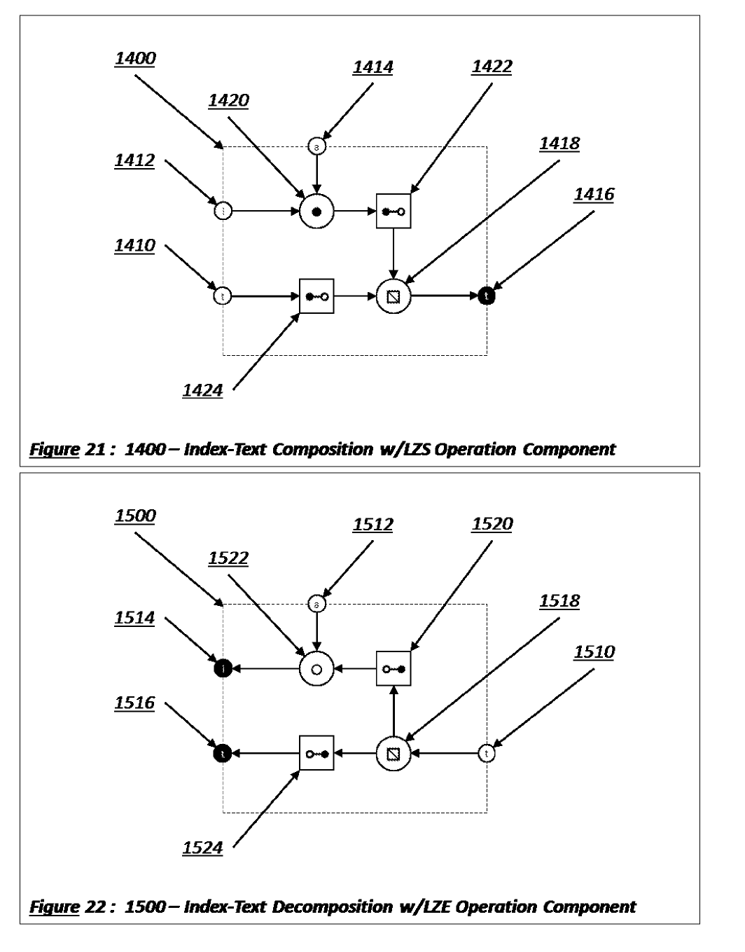

An indexed-text composition with leading-zero suppression operation component 1400, depicted in FIG. 21, according to an embodiment of present invention, is comprised of:
(1) an interface comprised of a text source 1410, an index source 1412, a mask source 1414, a text sink 1416, and;
(2) a set of operators comprised of a data structure operator 1418, a group operator 1420, index LZS operator 1422 and as text LZS operator 1424.

A group operator 1420, according to an embodiment of present invention, is an operation that possesses the properties defining of an operation of a mathematical group structure.

Index LZS operator 1422 and text LZS operator 1424 are instances of a leading-zero suppression operation component 1000 according to an embodiment of present invention

An indexed-text composition with leading-zero suppression operation component 1400, according to an embodiment of present invention:
(1) accepts a unit of data as text at text source 1410, accepts a unit of data as an index at index source 1412, accepts an index-mask 116 at mask source 1414, and;
(2) performs an operation, with index accepted at index source 1412 and index-mask 116 accepted at mask source 1414, using group operator 1420, and;
(3) performs an operation on a result produced by group operator 1420 using index LZS operator 1422, and;
(4) performs an operation on text value accepted at text source 1410 using text LZS operator 1422, and;
(5) performs an operation, with a result produced by index LZS operator 1422 and a result produced by text LZS operator 1424, using data structure operation 1418 to produce an indexed-text data structure 130, and;
(6) presents a result produced by data structure operator 1418 at text sink 1416.
   Indexed-Text Decomposition w/LZE Operation Component 1500

An indexed-text decomposition with leading-zero expansion operation component 1500, depicted in FIG. 22, according to an embodiment of present invention, is comprised of:
(1) an interface comprised of a text source 1510, a mask source 1512, an index sink 1514, a text sink 1516, and;
(2) a set of operators comprised of a data splitter operator 1518, a group operator 1522, an index LZE operator 1520, a text LZE operator 1524.

Index LZE operator 1520 and text LZE operator 1524 are instances of a leading-zero expansion operation component 1100 according to an embodiment of present invention.

A group operator 1522, according to an embodiment of present invention, is a functional inverse to a corresponding group operation 1422. A group operator 1522, according to an embodiment of present invention, serves the effective purpose of an inverse operator within a mathematical group structure. Examples of mathematical operators functioning as inverses within a mathematical group structure being the commonly understood functions of “addition” and “subtraction”.

An indexed-text decomposition with leading-zero expansion operation component 1500, according to an embodiment of present invention:
(1) accepts an indexed-text data structure 140 with leading-zero suppressed elements as a unit of text at text source 1510, accepts a index-mask 116 at mask source 1512, and;
(2) performs an operation, with text value accepted at text source 1510, using data splitting operation 1518 to produce data element 142 and data element 144 as independent units of data text and index, respectively, and;
(3) performs an operation with data element 142 as index result of data splitting operation 1518 using index LZE operator 1520, and;
(4) performs an operation, with a result of index LZE operator 1520 and index-mask 116 accepted at mask source 1512, using group operator 1522, and;
(5) presents a result of group operator 1522 at index sink 1514, and;
(6) performs an operation with data element 144 as text result of data splitting operation 1518 using text LZE operator 1524, and;
(7) presents a result of text LZE operator 1524 at text sink 1516.

### Index Computation Operation Component 1600

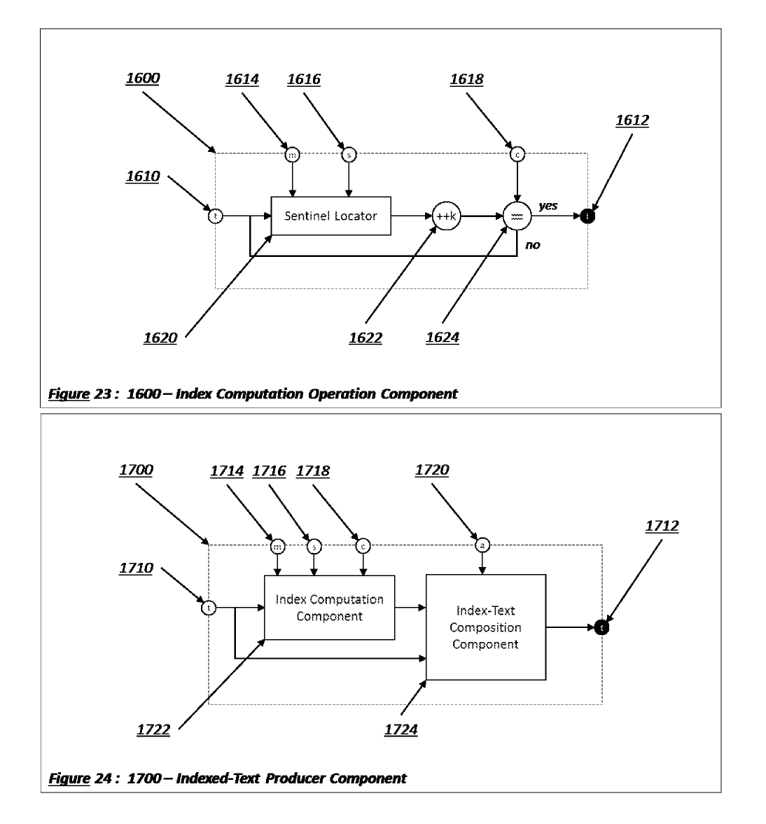

An index computation operation component 1600, depicted in FIG. 23, according to an embodiment of present invention, is comprised of:
(1) an interface comprised of a text source 1610, and index sink 1612, a key-modulus source 1614, a key-sentinel source 1616, a sentinel-composite source 1618, and;
(2) a sentinel locator component 1620, and;
(3) a set of operators comprised of an index-counter operator 1622, a is-composite-check operator 1624.

A sentinel locator component 1620, according to an embodiment of present invention, is an instance of sentinel locator operation component 160.

An index computation operation component 1600, according to an embodiment of present invention, works by repetitively incrementing an index count when an instance of a key-sentinel 112 is located by sentinel locator component 1620 until sentinel-composite 118 produced by sentinel locator component 1620 is equivalent to sentinel-composite 118 accepted at sentinel-composite source 1618, then presenting the resulting index count as the index of the sentinel-composite 118 accepted at sentinel-composite source 1618.

An index computation operation component 1600, according to an embodiment of present invention:
(1) accepts a unit of data as text at text source 1610, accepts a key-modulus 110 at key-modulus source 1614, accepts a key-sentinel 112 at key-sentinel source 1616, accepts a unit of data as a sentinel-composite 118 at sentinel-composite source 1618, and;
(2) performs an operation with text accepted at text source 1610, and a key-modulus 110 accepted at key-modulus source 1614 and a key-sentinel 112 accepted at key-sentinel source 1616, using sentinel locator component 1620, and;
(3) where a result is produced by sentinel locator component 1620 performs an operation using index-counter operator 1622, and;
(4) performs an equivalence operation of last result produced by sentinel locator component 1620 and a sentinel-composite 118 accepted at sentinel-composite source 1618 using is-composite-check operator 1624, and;
(5) where equivalence operation of is-composite-check operator 1624 is unsuccessful repeats at sentinel locator component 1620 using last result produced by sentinel locator component 1620 as text, and;
(6) where equivalence operation of is-composite-check operator 1624 is successful presents index count as an index value at index sink 1612.

### Indexed-Text Producer Component 1700

An indexed-text producer component 1700, depicted in FIG. 24, according to an embodiment of present invention, is comprised of:
(1) an interface comprised of a text source 1710, and text sink 1712, a key-modulus source 1714, a key-sentinel source 1716, a sentinel-composite source 1718, an index-mask source 1720, and;
(2) an index computation component 1722, and;
(3) an index-text composition component 1724.

An index computation component 1722, according to an embodiment of present invention, is an instance of index computation operation component 1600.

An index-text composition component 1724, according to an embodiment of present invention, is an instance of either indexed-text composition operation component 1200 or indexed-text composition with leading-zero suppression operation component 1400.

An indexed-text producer component 1700, according to an embodiment of present invention:
(1) accepts a unit of data as text at text source 1710, a key-modulus 110 at key-modulus source 1714, a key-sentinel 112 at key-sentinel source 1716, a unit of data as a sentinel-composite 118 at sentinel-composite source 1718, an index-mask 116 at index-mask source 1720, and;
(2) performs an operation, with text accepted at text source 1710 and key-modulus 110 accepted at key-modulus source 1714 and key-sentinel 112 accepted at key-sentinel source 1716 and sentinel-composite 118 accepted at sentinel-composite source 1718, using index computation component 1722, and;
(3) performs an operation, with a result produced by index computation component 1722 as index and text accepted at text source 1710 as text and index-mask 116 accepted at index-mask source 1720, using index-text composition component 1724 to produce an indexed-text data structure 140, and;
(4) presents a result produced by index-text composition component 1724 as text in form of indexed-text data structure 140 at text sink 1712.

### Encipher Preprocessor Component 1800

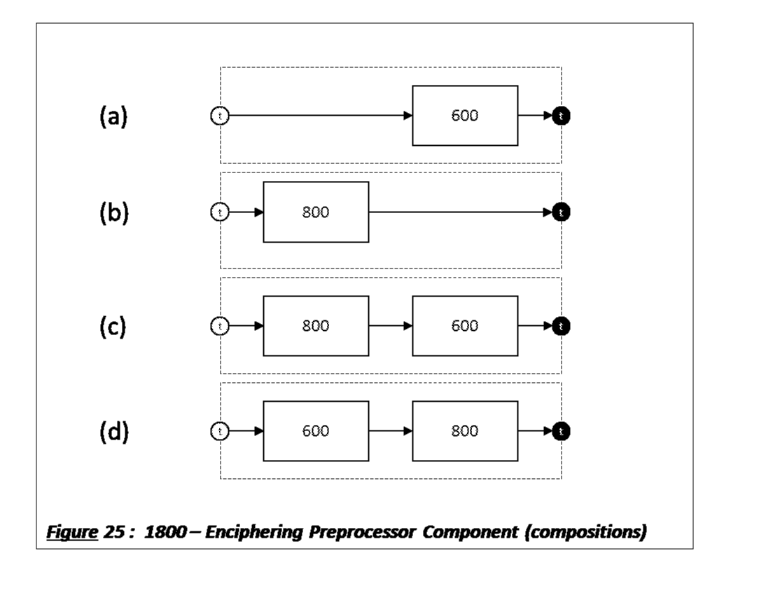

An encipher preprocessor component 1800, according to an embodiment of present invention, is an ordered composition, depicted in FIG. 25, of some instance of encipher vector group operation component 600 and/or encipher feedback group operation component 800.

### Decipher Post-Processor Component 1900

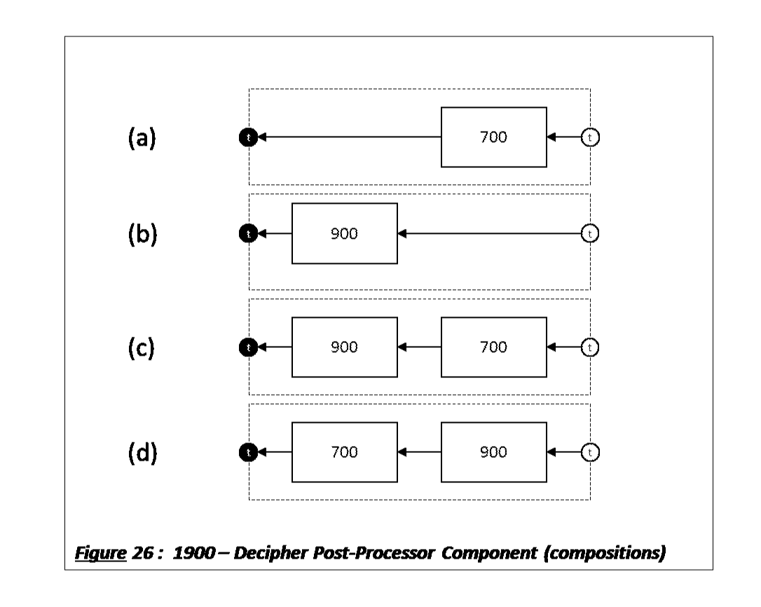

An decipher post-processor component 1900, according to an embodiment of present invention, is an ordered composition, depicted in FIG. 26, of some instance of decipher vector group operation component 700 and/or decipher feedback group operation component 900.

A cipher system, according to an embodiment of present invention, employs complimentary compositions of an encipher preprocessor component 1800 and a decipher post-processor component 1900 to assure enciphered text is correctly deciphered.

### Encipher Component 2000

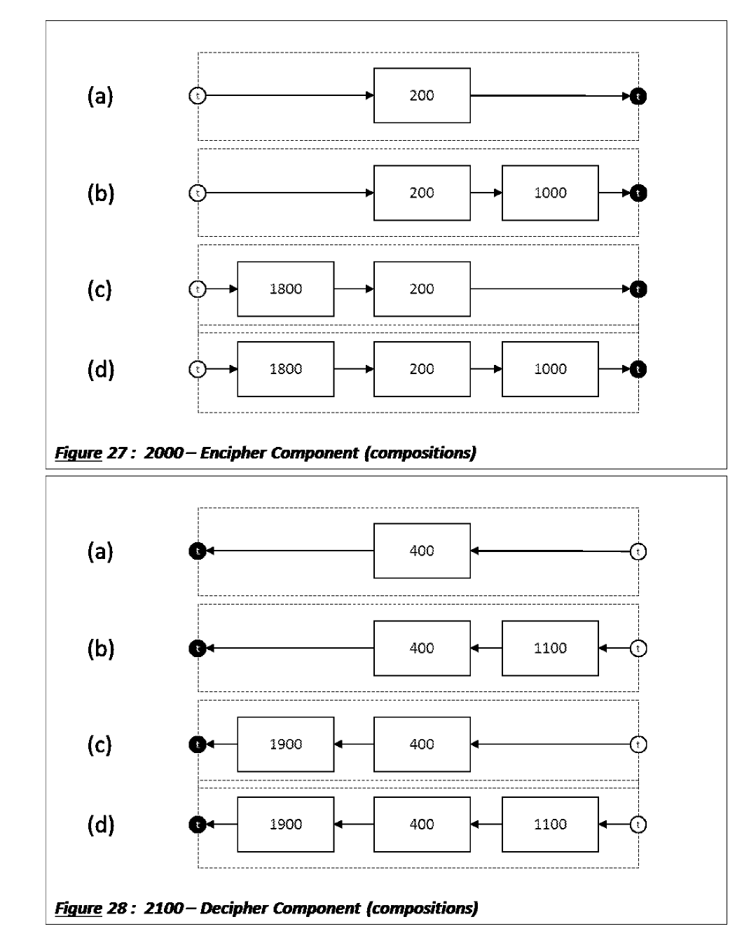

An encipher component 2000, according to an embodiment of present invention, is an ordered composition, depicted in FIG. 27, of instance of encipher preprocessor component 1800, encipher-primitive operation component 200, leading-zero suppression component 1000.

An encipher component 2000, according to an embodiment of present invention, performs enciphering of text using an instance of an encipher-primitive operation component 200, where text processed by encipher-primitive operation component 200 may itself be preprocessed by some instance of an encipher preprocessor component 1800 and may be post processed by an instance of an leading-zero suppression component 1000.

### Decipher Component 2100

An decipher component 2100, according to an embodiment of present invention, is an ordered composition, depicted in FIG. 28, of instance of decipher post-processor component 1900, decipher-primitive operation component 400, leading-zero expansion component 1100.

An decipher component 2100, according to an embodiment of present invention, performs deciphering of text using an instance of an decipher-primitive operation component 400, where text processed by decipher-primitive operation component 400 may be preprocessed by an instance of an leading-zero expansion component 1100 and may be post-processed by some instance of an decipher post-processor component 1900.

A cipher system, according to an embodiment of present invention, employs complimentary compositions of an encipher component 2000 and a decipher component 2100 to assure enciphered text is correctly deciphered.

### Indexed Encipher Component 2200

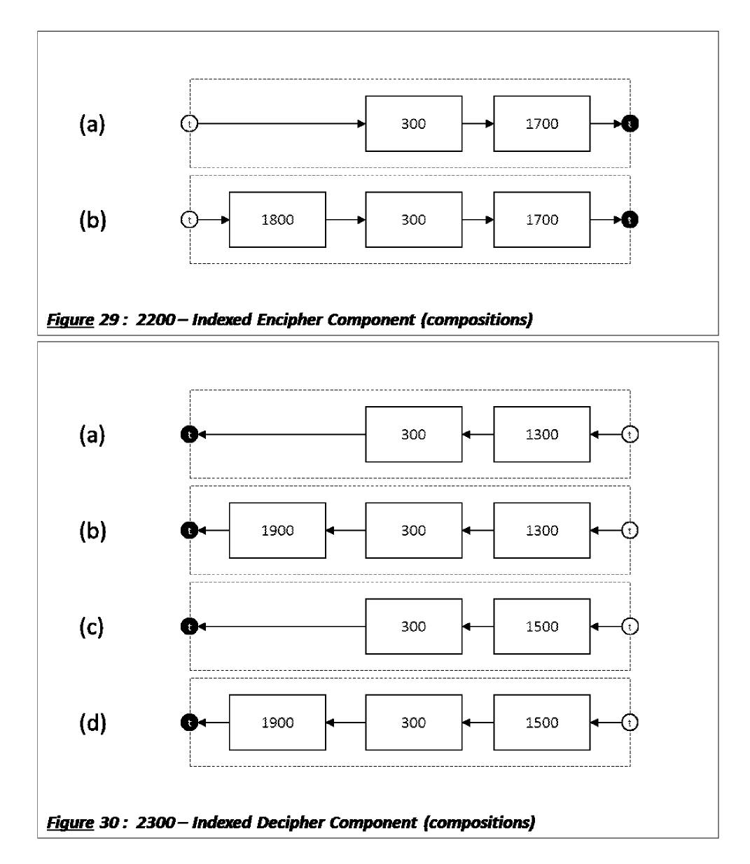

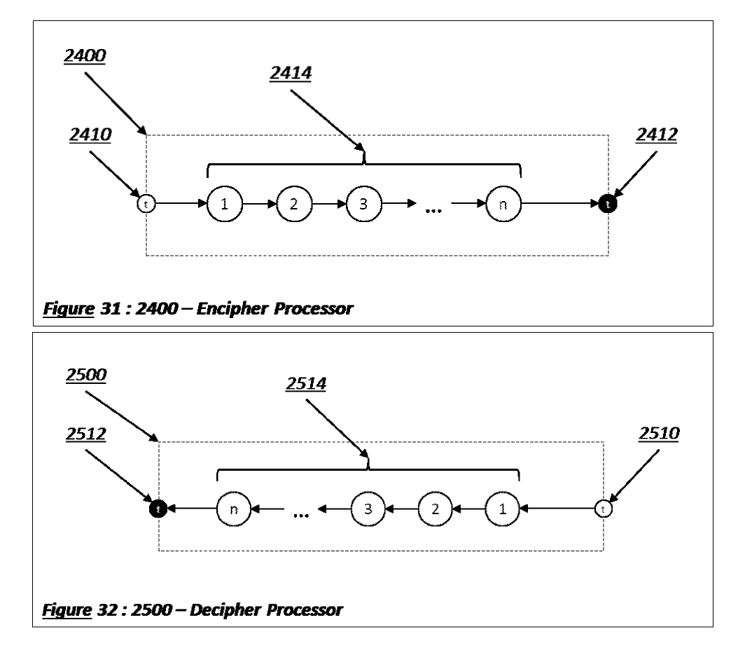

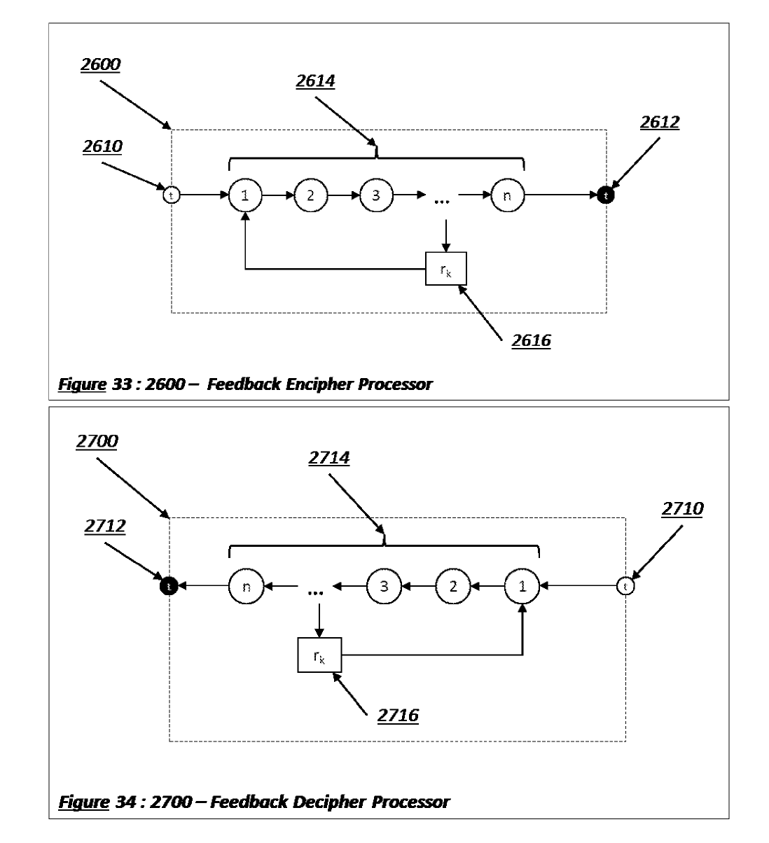

An indexed encipher component 2200, according to an embodiment of present invention, is an ordered composition, depicted in FIG. 29, of instance of encipher preprocessor component 1800, encipher-primitive with composite sink operation component 300, and indexed-text producer component 1700.

An indexed encipher component 2200, according to an embodiment of present invention, performs enciphering of text using an instance of an encipher-primitive with composite sink operation component 300, where text processed by primitive with composite sink operation component 300 may itself be preprocessed by some instance of an encipher preprocessor component 1800 and is post processed by an instance of an indexed-text producer component 1700.

### Indexed Decipher Component 2300

An indexed encipher component 2300, according to an embodiment of present invention, is an ordered composition, depicted in FIG. 30, of instance of decipher post-processor component 1900, decipher-primitive with index operation component 500, and either indexed-text decomposition operation component 1300 or indexed-text decomposition with leading-zero expansion operation component 1500.

An indexed encipher component 2100, according to an embodiment of present invention, performs deciphering of text using an instance of an decipher-primitive with index operation component 500, where text processed by decipher-primitive with index operation component 500 is preprocessed by an instance of either indexed-text decomposition operation component 1300 or indexed-text decomposition with leading-zero expansion operation component 1500, and may be post-processed by some instance of an decipher post-processor component 1900.

A cipher system, according to an embodiment of present invention, employs complimentary compositions of an indexed encipher component 2200 and a indexed decipher component 2300 to assure enciphered text is correctly deciphered.

### Processor Elements

### Encipher Processor 2400

A encipher processor 2400, according to an embodiment of present invention, is a sequence of enciphering components 2414, comprised of some number of encipher component 2000 or indexed encipher component 2200, where said components are ordered such that:
(1) some component of sequence of enciphering components 2414 processes some unit of data presented as text to processor at a text source 2410, and;
(2) each subsequent component of sequence of enciphering components 2414 processes as text the result of an immediate predecessor component of sequence of enciphering components 2414 in successive order, and;
(3) a result of some component of sequence of enciphering components 2614 as final component in successive order is presented as text at text sink 2412.

### Decipher Processor 2500

An decipher processor 2500, according to an embodiment of present invention, is a sequence of deciphering components 2514, comprised of some number of decipher component 2100 or indexed decipher component 2300, where said components are ordered such that:
(1) one component of sequence of deciphering components 2514 processes some unit of data presented as text to processor at a text source 2510, and;
(2) each subsequent component of sequence of deciphering components 2514 processes as text the result of an immediate predecessor component of sequence of deciphering components 2514 in successive order, and;
(3) a result of some component of sequence of deciphering components 2514 as final component in successive order is presented as text at text sink 2512.

A cipher system, according to an embodiment of present invention, employs encipher processor 2400 and decipher processor 2500 comprised of complimentary sequences of respective components.

### Feedback Encipher Processor 2600

A feedback encipher processor 2600, according to an embodiment of present invention, is a sequence of enciphering components 2614, comprised of some number of encipher component 2000 or indexed encipher component 2200, where some number of said components provides a feedback sink, and where said components are ordered such that:
(1) some component of sequence of enciphering components 2614 processes some unit of data presented as text to processor at a text source 2610, and;
(2) each subsequent component of sequence of enciphering components 2614 processes as text the result of an immediate predecessor component of sequence of enciphering components 2614 in successive order, and;
(3) a result of some component of sequence of enciphering components 2614 is feedback to a feedback source of some predecessor component of sequence of enciphering components 2614, and;
(4) a result of some component of sequence of enciphering components 2614 as final component in successive order is presented as text at text sink 2612.

### Feedback Decipher Processor 2700

A feedback decipher processor 2700, according to an embodiment of present invention, is a sequence of deciphering components 2714, comprised of some number of decipher component 2100 or indexed decipher component 2300, where some number of said components provides a feedback sink, and where said components are ordered such that:
(1) some component of sequence of deciphering components 2714 processes some unit of data presented as text to processor at a text source 2710, and;
(2) each subsequent component of sequence of deciphering components 2714 processes as text the result of an immediate predecessor component of sequence of deciphering components 2714 in successive order, and;
(3) a result of some component of sequence of deciphering components 2714 is feedback to a feedback source of some predecessor component of sequence of deciphering components 2714, and;
(4) a result of some component of sequence of deciphering components 2714 as final component in successive order is presented as text at text sink 2712.

A cipher system, according to an embodiment of present invention, employs feedback encipher processor 2600 and feedback decipher processor 2700 comprised of complimentary sequences of respective components.

### Basic Concept of Operation

A cipher system, according to an embodiment of present invention, employs an encipher-primitive to produce a residual of a mathematical congruence operation, most commonly referred to as a modulus operation, using a prime number base. Prior to computation of residual, a unit of data accepted as text, is combined with a sentinel, where the simplest composition is to prefix, suffix or both the text. Given that some prime number bases can produce multiple instances of a given sentinel in the sequence produced by modular inverse (inverse modulus) operation an index of the specific instance within the sequence of instances may be injected into the resulting cipher-text of the encipher-primitive.

Said cipher system employs a decipher primitive to produce the original plaintext by producing a sequence of candidate values using a modular inverse (inverse modulus) operation that looks for the first instance of the sentinel used during encipher-primitive operation, or in the case where an index was provided the specific indexed instance of the sentinel.

A cipher system, according to an embodiment of present invention, may use a vector to provide an element of confusion, and may use feedback to produce an element of diffusion.

A cipher system, according to an embodiment of present invention, may use a mask to provide an element of confusion in relation to indices incorporated into cipher-text by an encipher process step.

A cipher system, according to an embodiment of present invention, may use multiple instances of complementary encipher-primitives and decipher-primitives, in any combination with other mechanisms to increase complexity of resulting cipher.

A cipher system, according to an embodiment of present invention, may use one or more key-primitive 100, where a multitude of key-primitive 100 may be statically provided or produced by dynamic method, and; where produced by dynamic method present as a sequence of key-primitive 100 of length equal or greater than units of plaintext processed. Said dynamic methods may be any of the number of common or well-known processes suited to selection of relevant data values, or some lesser known methods, or some undisclosed method of an implementer of an embodiment of present invention. A preferred method for dynamic selection of prime value of key-modulus being use of well-known cryptographic pseudo-random number generation to produce member index of a defined set of prime numbers.

A number of cipher system configurations, each conforming to an embodiment of present invention, may be produced by the practical combination of the described components for an embodiment of present invention.

A cipher system, according to an embodiment of present invention, may perform as either a byte-wide stream cipher, or a block cipher. A cipher system, according to an embodiment of present invention, employed as a block cipher does not require, but may use, modes of operation required of commonly known symmetric ciphers for encryption of data sets greater than the key material size.

1. A system and method of cipher where said cipher employs as key-material (100) to cipher primitive processes a unit of data comprised of: a unit of data, identified as a key-sentinel (112) where said unit of data functions as a sentinel indicating completion of a deciphering process step, and; a unit of data, identified as a key-modulus (110) where said unit of data is a prime number, represented in context of processing, that functions as a cipher-key in a cipher processing step.

2. A system and method of claim 1 where said cipher employs a mechanism of data loss (200 & 300) in an enciphering process, and; where said data loss is produced by a mathematical congruence operation (222 & 322), and; where said mathematical congruence operation has as base a prime number (110), and; where said cipher employs a mechanism of data gain (400 & 500) in deciphering process, and; where said data gain is produced by a mathematical modular inverse (420 & 520).

3. A system and method of claim 2 where said cipher produces in an enciphering process step (200 & 300) a residual, by application of a mathematical congruence operator (i.e., modulus operation) (222 & 322), as resulting cipher-text of enciphering process step.

4. A system and method of claim 3 where said data loss of an enciphering process step is made invertible to a deciphering process step by presence of an identifiable distinct sentinel (112) composed within text (220 & 320) at said enciphering process step.

5. A system and method of claim 4 where said cipher reproduces in a deciphering process step (400 & 500) a plaintext value from a residual presented as cipher-text produced by an enciphering process step (200 & 300).

6. A system and method of claim 5 where a data gain in a deciphering process step is obtained by means of a mathematical modular inverse (420 & 520), and; where said modular inverse is recognized complete in said deciphering process step by location (160) of the an identifiable distinct instance of a sentinel (112).

7. A system and method of claim 3 where said data loss of an enciphering process step is made invertible to a deciphering process step by presence of an identifiable distinct sentinel (112) composed within cipher-text (220 & 320) at said enciphering process step, and; inclusion in cipher-text of said enciphering step an index value, where said index value is an index of a specific instance (1600) of said identifiable distinct sentinel (112) in modular inverse sequence of identifiable distinct sentinel instances.

8. A system and method of claim 7 where said cipher reproduces in a deciphering process step (400 & 500) a plaintext value from a residual presented as cipher-text produced by an enciphering process step (200 & 300).

9. A system and method of claim 8 where a data gain in a deciphering process step is obtained by means of a mathematical modular inverse (420 & 520), and; where said deciphering process step extracts (1300 & 1500) from cipher-text being processed an index included during enciphering, and; where said modular inverse is recognized complete in said deciphering process step by identification of the index identified instance (180) of all identifiable instances of a sentinel (112).
